(19) United States
(12) Patent Application Publication
(10) Pub. No.: US 2014/0277677 A1
(43) Pub. Date: Sep. 18, 2014

(54) PRODUCTION PROCESSING SYSTEM, CONTROL DEVICE FOR PRODUCTION PROCESSING, METHOD FOR CONTROLLING PRODUCTION PROCESSING AND STORAGE MEDIUM

(71) Applicant: TOKYO ELECTRON LIMITED, Tokyo (JP)

(72) Inventor: Takahiro ITO, Yamanashi (JP)

(73) Assignee: TOKYO ELECTRON LIMITED, Tokyo (JP)

(21) Appl. No.: 14/285,824

(22) Filed: May 23, 2014

Related U.S. Application Data
(63) Continuation of application No. PCT/JP2012/078919, filed on Nov. 8, 2012.

(30) Foreign Application Priority Data
Nov. 25, 2011 (JP) 2011-257726

(51) Int. Cl. G05B 19/402

(52) U.S. Cl. CPC G05B 19/402; G05B 2219/49001
USPC 700/114

(57) ABSTRACT

A production processing system includes a plurality of processing tools configured to process workpieces, an equipment which can be shared by the plurality of processing tools, a transfer device configured to transfer the workpieces to the plurality of processing tools, a host computer configured to create a transfer plan including information on timings for the workpieces to be carried in and carried out of the plurality of processing tools by the transfer device, a group controller configured to generate a use plan for the equipment based on acquired information, and a shared controller configured to control processing timings of the equipment and each of the plurality of processing tools based on the use plan, an operational state of the equipment, and use information including at least one of use reservation, inquiry, execution, and release information for the equipment by each of the plurality of processing tools.

### CROSS-REFERENCE TO RELATED APPLICATION

This application is a Continuation Application of PCT International Application No. PCT/JP2012/078919, filed Nov. 8, 2012, which claimed the benefit of Japanese Patent Application No. 2011-257726, filed on Nov. 25, 2011, the entire content of each of which is hereby incorporated by reference.

### TECHNICAL FIELD

The present disclosure relates to a production processing system in which a plurality of processing tools for processing workpieces shares an equipment, a control device for production processing, a method for controlling production processing and a storage medium storing a control program for production processing.

### BACKGROUND

In a manufacturing plant with a job-shop type production system (for example, a semiconductor device manufacturing plant or an organic EL device manufacturing plant), how the production may be executed is controlled by a MES (Manufacturing Execution System). In such a manufacturing plant, a production processing system is practically used, which includes a plurality of processing tools for processing workpieces, a transfer device for transferring the workpieces to each processing tool, a transfer control device for controlling operations of the transfer device, and a MES for determining which processing tool should process the workpieces, informing the transfer control device of a transfer destination of the workpieces, and informing the processing tool of the contents of process for the workpieces.

A related art discloses software including a procedure of communicating with a plurality of processing tools for processing workpieces, a procedure of communicating with a transfer device for transferring the workpieces between any processing tools, and a procedure of communicating with a production instruction device for instructing the processing tools to process the workpieces.

Another related art discloses that a MES of a plant and a MCS (Material Control System) for controlling an OHT (Overhead Hoist Transport) based on various instructions received from the MES share information such as plant layouts and so on in order to provide an efficient transfer.

Another related art discloses a process management system providing an instruction according to which, a processing tool is allowed to process other workpieces if the time taken for a workpiece that has to be preferentially processed to arrive at the processing tool is sufficiently long, and providing an instruction according to which, the processing tool waits for the workpiece to be preferentially processed if the time taken for the workpiece to be preferentially processed to reach the processing tool is short.

Another related art discloses a power supply system in which the arrival time taken for a workpiece to arrive at a processing tool is compared with the start-up time of the processing tool from a power saving state, and, if the arrival time is longer than the start-up time, the processing tool is put into the power saving state.

In some cases, the above-mentioned production system may use equipment associated with each processing tool. For example, a vacuum pump may be used in association with a film forming apparatus for manufacturing a semiconductor device.

In a case where one equipment is used for one processing tool, a plurality of equipment needs to be installed in a manufacturing plant. This may result in a great increase in costs and energy consumption.

In addition, even in a case where a plurality of processing tools shares one equipment, the equipment is controlled such that sending or receiving necessary information only occurs between the equipment and each of the processing tools, while the information is not shared among the processing tools. For that reason, the equipment cannot be necessarily considered efficiently sharable, which may lead to a concern about wasteful energy consumption of the equipment.

### SUMMARY

The present disclosure provides some embodiments of a production processing system, a control device for production processing, a method for controlling production processing and a storage medium storing a control program for production processing in which energy consumption is reduced by sharing equipment between a plurality of processing tools.

According to one embodiment of the present disclosure, there is provided a production processing system including: a plurality of processing tools configured to process workpieces, an equipment configured to be shared by the plurality of processing tools, a transfer device configured to transfer the workpieces to the plurality of processing tools, a host computer configured to acquire an operational state and an operational schedule including information regarding a timing for maintenance from the plurality of processing tools and configured to create a transfer plan including information on timings for the workpieces to be carried in and carried out of the plurality of processing tools by the transfer device, a group controller configured to acquire the operational state, the operational schedule and the transfer plan from the host computer and configured to generate a use plan for the equipment based on at least one of the acquired operational state, operation schedule and transfer plan, and a shared controller configured to control processing timings of the equipment and each of the plurality of processing tools based on the use plan, the operational state of the equipment, and use information including at least one of use reservation, inquiry, execution, and release information for the equipment by each of the plurality of processing tools.

The generation of the use plan by the group controller may be further based on a past use history of each of the plurality of processing tools.

The shared controller may switch an operational state of the equipment among a run state, a ready state and an idle state based on the use plan and the inquiry for the equipment, and the shared controller may reply to the processing tool on whether or not the use reservation for the equipment is available, based on the use plan.

According to another embodiment of the present disclosure, there is provided a production processing system including: a plurality of first processing tools configured to process workpieces, a plurality of second processing tools configured to process the workpieces, a first equipment configured to be shared by the plurality of first processing tools, a second equipment which can be shared by the plurality of second processing tools, a transfer device configured to transfer the workpieces to the plurality of first and second processing tools, a host computer configured to acquire an operational state and an operational schedule including information regarding a timing for maintenance from the plurality of first and second processing tools and configured to create a transfer plan including information on timings for the workpieces to be carried in and carried out of the plurality of first and second processing tools by the transfer device, an upper-level controller configured to acquire the operational state, the operational schedule and the transfer plan of the plurality of first and second processing tools from the host computer, a first group controller configured to acquire the operational state, the operational schedule and the transfer plan of the plurality of first processing tools from the upper-level controller and configured to generate a use plan for the first equipment based on at least one of the acquired operational state, operational schedule and transfer plan, a second group controller configured to acquire the operational state, the operational schedule and the transfer plan of the plurality of second processing tools from the upper-level controller and configured to generate a use plan for the second equipment based on at least one of the acquired operational state, operational schedule and transfer plan, a first shared controller configured to control processing timings of the first equipment and each of the plurality of first processing tools based on the use plan for the first equipment, the operational state of the first equipment, and use information including at least one of use reservation, inquiry, execution, and release information for the first equipment by each of the plurality of first processing tools, and a second shared controller configured to control processing timings of the second equipment and each of the plurality of second processing tools based on the use plan for the second equipment, the operational state of the second equipment, and use information including at least one of use reservation, inquiry, execution, and release information for the second equipment by each of the plurality of second processing tools.

Further, a common equipment sharable by the plurality of first and second processing tools may be provided, and the upper-level controller may create a use plan for the common equipment and controls a processing timing of the common equipment, based on at least one of the operational state, the operational schedule and the transfer plan of the plurality of first and second processing tools.

According to another embodiment of the present disclosure, there is provided a control device for controlling a plurality of processing tools configured to process workpieces, an equipment configured to be shared by the plurality of processing tools, and a transfer device configured to transfer the workpieces to the plurality of processing tools, including: an acquisition unit configured to acquire an operational state of the plurality of processing tools, an operational schedule including information regarding a timing for maintenance, and a transfer plan including information on timings for the workpieces to be carried in and out of the plurality of processing tools by the transfer device, a use plan generating unit configured to create a use plan for the equipment based on at least one of the acquired operational state, operational schedule and transfer plan, and a control unit configured to control processing timings of the equipment and each of the plurality of processing tools based on the use plan, the operational state of the equipment, and use information including at least one of use reservation, inquiry, execution, and release information for the equipment by each of the plurality of processing tools.

According to another embodiment of the present disclosure, there is provided a control method for controlling a plurality of processing tools configured to process workpieces, an equipment sharable by the plurality of processing tools, and a transfer device configured to transfer the workpieces to the plurality of processing tools, including: acquiring an operational state of the plurality of processing tools, an operational schedule including information regarding a timing for maintenance, and a transfer plan including information on timings for the workpieces to be carried in and out of the plurality of processing tools by the transfer device, creating a use plan for the equipment based on at least one of the acquired operational state, operational schedule and transfer plan, and controlling processing timings of the equipment and each of the plurality of processing tools based on the use plan, the operational state of the equipment, and use information including at least one of use reservation, inquiry, execution, and release information for the equipment by each of the plurality of processing tools.

According to another embodiment of the present disclosure, there is provided a non-transitory computer-readable storage medium storing a control program for controlling a plurality of processing tools configured to process workpieces, an equipment configured to be shared by the plurality of processing tools, and a transfer device configured to transfer the workpieces to the plurality of processing tools, the control program causing a computer to perform processes of: acquiring an operational state of the plurality of processing tools, an operational schedule including information regarding a timing for maintenance, and a transfer plan including information on timings for the workpieces to be carried in and out of the plurality of processing tools by the transfer device, creating a use plan for the equipment based on at least one of the acquired operational state, operational schedule and transfer plan, and controlling processing timings of the equipment and each of the plurality of processing tools based on the use plan, the operational state of the equipment, and use information including at least one of use reservation, inquiry, execution, and release information for the equipment by each of the plurality of processing tools.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a block diagram illustrating an example of a configuration for a production processing system according to a first embodiment of the present disclosure.

FIG. 2 is a block diagram illustrating an example of a configuration for processing tools 41 and an equipment 51.

FIG. 3 is a block diagram illustrating an example of a hardware configuration for a group controller 2.

FIG. 4 is a block diagram of functions implemented by executing a group control program by a CPU 21.

FIG. 5 is a flow chart illustrating an example of a processing operation of an acquisition unit 201, a use plan generating unit 202 and a transmitting unit 203.

FIG. 6 is a block diagram illustrating an example of a hardware configuration for a shared controller 3.

FIG. 7 is a block diagram of functions implemented by executing a common control program by a CPU 31.

FIG. 8 is a flow chart illustrating an example of a processing operation of an acquisition unit 301 and a control unit 302.

FIG. 9 is a block diagram illustrating an example of a configuration for a production processing system according to a second embodiment of the present disclosure.

FIG. 10 is a block diagram illustrating an example of a configuration for a production processing system as a modification of FIG. 9.

FIG. 11 is a block diagram illustrating an example of a configuration for a production processing system according to a third embodiment of the present disclosure.

FIG. 12 is a block diagram illustrating an example of a configuration for a production processing system as a modification of FIG. 11.

### DETAILED DESCRIPTION

Embodiments of the present invention will now be described in detail with reference to the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### First Embodiment

FIG. 1 is a block diagram illustrating an example of a configuration for a production processing system according to a first embodiment of the present disclosure. The production processing system includes a production management host computer 1 (hereinafter simply referred to as a “host 1”), a group controller 2, a shared controller 3, a processing tool group 4 including a plurality of processing tools 41, a common equipment group 5 including one or more equipment 51 shared by each of the processing tools 41, and a transfer system 6.

The host 1 constitutes a MES (Manufacturing Execution System) and includes a scheduler module for creating a production plan according to the type and specification of products to be manufactured, a dispatcher module for specifying one of the processing tools 41 by which a workpiece is to be processed according to the created production plan and providing the processing tool 41 with process conditions (recipe) for the workpiece, and so on.

The host 1 generates production execution control information to control an operation of the processing tool 41 and the transfer system 6 and transmits it to the group controller 2. The production execution control information includes a transfer plan to specify a timing at which the workpiece such as a semiconductor wafer or the like is carried into the processing tool 41 or a timing at which the workpiece processed in the processing tool 41 is carried out, an operational state of the processing tool 41 acquired from each of the processing tools 41, and an operational schedule to specify a timing at which maintenance such as part replacement, cleaning, periodic inspection and the like is performed. For example, the operational state includes a run state where the processing tool 41 processes the workpiece, a ready state where it is ready to quickly start processing when the workpiece is received, and an idle state where it rests.

The group controller 2 acquires the production execution control information such as the operational state, the operational schedule and the transfer plan from the host 1. The group controller 2 generates a use plan for the equipment 51 based on at least a portion of the production execution control information, and transmits it to the shared controller 3.

The shared controller 3 acquires the use plan from the group controller 2, an operational state of the equipment 51 from the equipment 51, and use information on the equipment 51 from each of the processing tools 41. The operational state of the equipment 51 includes a run state, a ready state and an idle state, like the operational state of the processing tool 41. The use information on the equipment 51 includes use reservation, inquiry, execution, and release information for a particular equipment 51, as will be described later. The shared controller 3 controls processing timings of the processing tool 41 and the equipment 51 based on the acquired information.

The processing tool group 4 includes a plurality of processing tools 41. Each of the processing tools 41 is a substrate processing tool such as a plasma CVD device, plasma etching device, sputtering device, PVD device or the like for processing a workpiece such as, for example, a glass substrate used to manufacture an organic EL device, a silicon wafer used to manufacture a semiconductor device, or the like. The plurality of processing tools 41 constituting one processing tool group 4 may be of the same type or may be devices corresponding to a series of processing sequences.

The common equipment group 5 includes one or more equipment 51. Examples of the equipment 51 may include a vacuum pump for setting the internal pressure of a chamber of the processing tool 41 to a desired degree of vacuum, a circulating device for circulating water or liquid chemicals used in the processing tools 41, and a detoxifying device for detoxifying a gas discharged from the processing tools 41. If the common equipment group 5 is constituted by a plurality of equipment 51, the plurality of equipment 51 may be of either the same or the different types.

The equipment 51 is shared by the processing tools 41 in the processing tool group 4 and any of the processing tools 41 in the processing tool group 4 may also use any equipment 51 in the common equipment group 5. In other words, instead of one equipment 51 being associated with one of the processing tools 41, the equipment 51 is associated with one processing tool group 4 including the plurality of processing tools 41. Such sharing of the equipment can reduce the number of equipment 51 and achieve energy saving.

In addition, in order for one of the processing tools 41 to use the equipment 51, the use information on the equipment 51, such as the use reservation, the inquiry, the execution, and the release of the equipment, is transmitted to the shared controller 3 which may recognize the use plan, instead of being directly transmitted to the equipment 51. For that reason, the processing tools 41 may not necessarily have a function of communicating with the equipment 51.

The transfer system 6 includes a transfer control device 61 and a transfer device 62. The transfer device 62 is, for example, a transfer shuttle running on a rail installed on a ceiling or floor, an unmanned transfer vehicle running along a predetermined route, etc., and transfers a FOUP (Front Open Unified Pod). Based on an instruction from the transfer control device 61, the transfer device 62 transfers workpieces accommodated in FOUPs while being moved between the plurality of processing tools 41 and a stoker storing the FOUPs.

The transfer control device 61 constitutes a MCS (Material Control System) and controls operations of the transfer device 32 based on a transfer plan given by the host 1.

FIG. 2 is a block diagram illustrating an example of a configuration of the processing tools 41 and the equipment 51. Shown in the figure is an example where the processing tool 41 is a multi-chamber type substrate processing system and the equipment 51 is a vacuum pump.

In order to deliver FOUPs accommodating workpieces W, the processing tool 41 includes a LM (Load Module) 43 having first and second LPs (Load Ports) 42a and 42b installed thereon, FOUPs being mounted on the first and second LPs (Load Ports) 42a and 42b. A TM (Transfer Module) 45 is connected to the LM 43 via LLMs (Load Lock Modules) 44a and 44b. A vacuum robot (not shown) in the TM 45 transfers the workpieces W that are carried in via the LLMs 44a and 44b, to PMs (Process Modules) 46a to 46d. The PMs 46a to 46d perform a predetermined process for the workpieces W based on a recipe. The processed workpieces W are collected in FOUPs loaded on the first LP 42a or the second LP 42b through a path reverse to the carrying-in and are carried out with one FOUP as a unit.

In the multi-chamber type substrate processing system shown in FIG. 2, the PMs 46a to 46d and the TM 45 remain vacuum at all times and the LLMs 44a and 44b and the TM 45 are partitioned by a gate valve (not shown). With the LLMs 44a and 44b remaining vacuum, the gate valve is opened, and the workpieces W are transferred between the PMs 46a to 46d and the LLMs 44a and 44b. The vacuum pump as the equipment 51 makes the LLMs 44a and 44b vacuum.

The vacuum pump is connected to the LLMs 44a and 44b of a plurality of substrate processing systems and is shared by the plurality of substrate processing systems. More specifically, a gate valve 47 is disposed in a pipe connecting the LLMs 44a and 44b and the vacuum pump. When the gate valve 47 is opened, the LLMs 44a and 44b can be made vacuum.

The shared equipment 51 may be a circulating device or a detoxifying device. If the equipment 51 is the detoxifying device, since there is a risk of causing a chemical reaction by mixture of a plurality of gases, it is desirable that a device suitable to remove or collect a particular gas be further provided.

FIG. 3 is a block diagram illustrating an example of a hardware configuration of the group controller 2. The group controller 2 includes a CPU (Central Processing Unit) 21, a disk device 22, a main memory 23 and a network interface 24. These components of the group controller 2 are interconnected via a bus 25.

The disk device 22 stores a group control program to be executed by the CPU 21. The disk device 22 also receives and stores production execution control information including an operational state, an operational schedule and a transfer plan for each of the processing tools 41 from the host 1 via the network interface 24. The disk device 22 is, for example, a hard disk. The group control program may be stored in a ROM or a magnetic tape (both not shown) instead of the disk device 22.

The CPU 21 loads the group control program in the disk device 22 into the main memory 23 and executes the group control program.

FIG. 4 is a block diagram of functions implemented by the CPU 21 executing the group control program. An acquisition unit 201, a use plan generating unit 202 and a transmitting unit 203 are implemented by the execution of the group control program.

FIG. 5 is a flow chart illustrating an example of a processing operation of the acquisition unit 201, the use plan generating unit 202 and the transmitting unit 203. First, the acquisition unit 201 acquires the production execution control information stored in the disk device 22 (Step 51).

Next, the use plan generating unit 202 analyzes the operational state, the operational schedule and the transfer plan for each of the processing tools 41, included in the production execution control information and generates a use plan of the equipment 51 (Step S2). For example, based on the operational schedule for each of the processing tools 41, the use plan generating unit can predict which of the processing tools 41 is likely to use the equipment 51. In addition, based on the transfer plan, the use plan generating unit 202 may predict a timing at which a workpiece is carried into the processing tool 41 to trigger the use of the equipment 51, and assign an equipment 51 to be used by the processing tool 41. In addition, in consideration of the past processing history of the processing tool 41, the use plan generating unit 202 may generate the use plan. For example, based on the operational state and the past processing history for each of the processing tools 41, the use plan generating unit 202 can predict a timing at which the processing tool 41 starts or ends to use the equipment 51.

By using the production execution control information in this manner, the group controller 2 can predict the processing of each of the processing tools 41 in advance and generate the use plan of the equipment 51.

Subsequently, the transmitting unit 203 transmits the generated used plan to the shared controller 3 (Step S3).

Next, the shared controller 3 will be described. FIG. 6 is a block diagram illustrating an example of a hardware configuration of the shared controller 3. The hardware configuration of the shared controller 3 is similar to that of the group controller 2 of FIG. 3 and therefore, the shared controller 3 will be described with an emphasis placed on differences therebetween.

The disk device 32 stores a common control program to be executed by a CPU 31. In addition, the disk device 32 receives and stores a use plan from the group controller 2, an operational state of the equipment 51 from the equipment 51, and use information for the equipment 51 from each of the processing tools 41 via a network interface 34.

FIG. 7 is a block diagram of functions implemented by executing the common control program by the CPU 31. An acquisition unit 301 and a control unit 302 are implemented by executing the common control program.

FIG. 8 is a flow chart illustrating an example of a processing operation for the acquisition unit 301 and the control unit 302.

The acquisition unit 301 acquires the use plan received from the group controller 2 and stored in the disk device 32 (Step S11). In addition, the acquisition unit 301 acquires the equipment operational state received from the equipment 51 and stored in the disk device 32 (Step S12). In addition, the acquisition unit 301 acquires the use information for the equipment 51 received from each of the processing tools 41 and stored in the disk device 32 (Step S13). Steps S11 to S13 may be performed in a random order.

Based on the acquired use plan, the operational state and the use information, the control unit 302 controls processing timings of the processing tools 41 and the equipment 51 (Step S14). More specifically, the control unit 302 instructs the processing tool 41 to make a reservation for using the equipment or to switch its operational state while sending an instruction for the processing to the equipment 51, so as to adjust the common use of the equipment 51.

For example, based on the use plan, the control unit 302 sets an operational state of the equipment 51 from an idle state to a ready state when a scheduled use timing for the equipment 51 approaches. If there is an inquiry about using the equipment 51 from the processing tool 41 according to the use plan, the control unit 302 sets the operational state of the equipment 51 to a run state to perform a processing for the workpieces. Since the equipment 51 is put in the run state in advance, the equipment 51 can start processing quickly. In addition, the control unit 302 sets the operational state of the equipment 51 to the idle state at a timing at which the processing tool 41 ends the use of the equipment 51 based on the use plan.

In addition, upon receiving an inquiry about the use reservation of the equipment 51 from the processing tool 41, the control unit 302 may determine whether or not the use reservation is allowable based on the use plan, and reply to the querying processing tool 41.

In this manner, the previously-acquired use plan is used in controlling the processing tool 41 and the equipment 51 in the first embodiment, instead of being based only on the use information from the processing tool 41. Accordingly, the one or more equipment 51 in the common equipment group 5 can be efficiently shared, which can result in a reduction of the energy consumption.

In addition, although it has been illustrated in this embodiment that the group controller 2 and the shared controller 3 are separated from each other, these controllers may be integrated into a production control device. In this case, the transmitting unit 203 of the group controller 2 may be omitted, and the acquisition unit 301 of the shared controller 3 may directly acquire the use plan from the use plan generating unit 202.

### Second Embodiment

The above-described first embodiment involves controlling processing timings of the plurality of processing tools 41 and equipment 51 by means of one group controller 2 and one shared controller 3. In contrast, a second embodiment to be described below involves hierarchizing of controllers.

FIG. 9 is a block diagram illustrating an example of a configuration for a production processing system according to the second embodiment of the present disclosure. In FIG. 9, the same elements as FIG. 1 are denoted by the same reference numerals and the second embodiment will be described with an emphasis placed on the differences therebetween.

The production processing system shown in FIG. 9 includes a group 100A including a group controller 2A, a shared controller 3A, a processing tool group 4A, a common equipment group 5A and a transfer system 6A, groups 100B and 100C having the same configuration as the group 100A, and an upper-level controller 7.

For example, upon receiving production execution control information of the plurality of processing tools 41 included in the processing tool groups 4A to 4C from the host 1, the upper-level controller 7 transmits the production execution control information of the plurality of processing tools 41 included in the processing tool group 4A to the group controller 2A. Similarly, the upper-level controller 7 transmits the production execution control information of the plurality of processing tools 41 included in the processing tool group 4B to the group controller 2B and transmits the production execution control information of the plurality of processing tools 41 included in the processing tool group 4C to the group controller 2C.

In the groups 100A to 100C, the group controllers 2A to 2C and the shared controllers 3A to 3C control the processing timings of the plurality of processing tools 41 and the equipment 51, respectively, similarly to the first embodiment.

Although a controller having two hierarchies of the upper-level controller 7 and the group controllers 2A to 2C is illustrated in FIG. 9, a controller having more than three hierarchies may be constructed in a recursive manner.

FIG. 10 is a block diagram illustrating an example of a configuration for a production processing system according to a modification of FIG. 9. FIG. 10 shows an example of a configuration for a controller having three hierarchies. The internal configuration of groups 100A to 100F is the same as that in FIG. 9 and is not therefore shown in FIG. 10. The production processing system of FIG. 10 further includes an uppermost-level controller 8. The uppermost-level controller 8 receives production execution control information of a plurality of processing tools 41 included in the groups 100A to 100F from the host 1. Then, the uppermost-level controller 8 transmits the production execution control information of the processing tools included in the groups 100A to 100C to an upper-level controller 7A and transmits the production execution control information of the processing tools included in the groups 100D to 100F to an upper-level controller 7B.

The same process as that in FIG. 9 is performed in the upper-level controller 7A and the groups 100A to 100C. The same process is performed in the upper-level controller 7B and the groups 100D to 100F.

In this manner, the optimal use of resources can be made between the processing tools, between the equipment, and between the processing tools and the equipment due to the hierarchizing of the controller in the second embodiment, which can result in improvement of productivity of the processing tools and the equipment, and hence reducing energy consumption.

### Third Embodiment

The above-described second embodiment involves sharing the equipment 51 within a group. In contrast, a third embodiment involves further including equipment which can be shared by a plurality of groups.

FIG. 11 is a block diagram illustrating an example of a configuration for a production processing system according to the third embodiment of the present disclosure. In FIG. 11, the same elements as FIG. 9 are denoted by the same reference numerals and the third embodiment will be described with an emphasis placed on the differences therebetween.

The production processing system shown in FIG. 11 further includes a common equipment 9 which can be shared by a plurality of processing tools 41 included in processing tool groups 4A to 4C. The upper-level controller 7 acquires production execution control information from the host 1, generates a use plan of the common equipment 9, and based on the generated use plan, controls a processing timing of the common equipment 9, such as performing a mediation process to use the common equipment 9 or switching an operational state of the common equipment 9. For example, if an operation load of the common equipment 9 exceeds a predetermined value, the upper-level controller 7 determines whether or not the processing tool groups 4A to 4C are allowed to use the common equipment 9 in order to prevent the common equipment 9 from undergoing an excessive load.

FIG. 12 is a block diagram illustrating an example of a configuration for a production processing system according to a modification of FIG. 11. FIG. 12 shows an example of a configuration provided with a three-hierarchical controller, similar to FIG. 10. In the production processing system, a plurality of processing tool groups that shares common equipment outside the groups is divided into groups, and upper-level controllers 7A and 7B are respectively provided so as to correspond to the groups. An uppermost-level controller 8 is provided between the upper-level controllers 7A and 7B and the host 1. Therefore, a planned use, a use arbitration and so on of the common equipment 9A and 9B may be possible.

In this manner, since equipment that may be shared by the plurality of groups is provided in the third embodiment, it is possible to more efficiently share equipment and to reduce energy consumption.

At least some of the host, the group controller and the shared controller described in the above embodiment may be implemented as hardware or software. In the latter, a program implementing at least some functions of the host, the group controller and the shared controller may be stored in a recording medium such as a flexible disk or a CD-ROM and may be read and executed by a computer. The recording medium may be either a removable recording medium such as a magnetic disk or an optical disk, or a fixed recording medium such as a hard disk or a memory.

In addition, the program implementing at least some functions of the host, the group controller and the shared controller may be distributed via a communication line (including wireless communication) such as Internet. In addition, with this program encoded, modulated or compressed, the program may be distributed via a wired line such as Internet, or a wireless line or with the program stored in a recording medium.

According to the present disclosure, since a use plan for a shared equipment is created and processing timings of the equipment and processing tools are controlled based on the use plan, it is possible to use the equipment efficiently and reduce energy consumption.

The present invention is not limited to the above describe embodiments and may be embodied in a variety of other forms without departing from the spirit of the disclosure. Indeed, a proper combination of the plurality of components described in the embodiments can form various inventions. For example, various omissions of the components in the embodiments may be made. Further, a proper combination of components over the different embodiments may be possible.

What is claimed is:

1. A production processing system comprising:
a plurality of processing tools configured to process workpieces;
an equipment configured to be shared by the plurality of processing tools;
a transfer device configured to transfer the workpieces to the plurality of processing tools;
a host computer configured to acquire an operational state and an operational schedule including information regarding a timing for maintenance from the plurality of processing tools and configured to create a transfer plan including information on timings for the workpieces to be carried in and carried out of the plurality of processing tools by the transfer device;
a group controller configured to acquire the operational state, the operational schedule and the transfer plan from the host computer and configured to generate a use plan for the equipment based on at least one of the acquired operational state, operation schedule and transfer plan; and
a shared controller configured to control processing timings of the equipment and each of the plurality of processing tools based on the use plan, the operational state of the equipment, and use information including at least one of use reservation, inquiry, execution, and release information for the equipment by each of the plurality of processing tools.

2. The production processing system of claim 1, wherein the use plan generated by the group controller is further based on a past use history of each of the plurality of processing tools.

3. The production processing system of claim 1, wherein the shared controller switches an operational state of the equipment among a run state, a ready state and an idle state based on the use plan and the inquiry for the equipment.

4. The production processing system of claim 2, wherein the shared controller switches an operational state of the equipment among a run state, a ready state and an idle state based on the use plan and the inquiry for the equipment.

5. The production processing system of claim 1, wherein the shared controller replies to the processing tool on whether or not the use reservation for the equipment is available based on the use plan.

6. The production processing system of claim 2, wherein the shared controller replies to the processing tool on whether or not the use reservation for the equipment is available based on the use plan.

7. The production processing system of claim 3, wherein the shared controller replies to the processing tool on whether or not the use reservation for the equipment is available based on the use plan.

8. A production processing system comprising:
a plurality of first processing tools configured to process workpieces;
a plurality of second processing tools configured to process the workpieces;
a first equipment configured to be shared by the plurality of first processing tools;
a second equipment configured to be shared by the plurality of second processing tools;
a transfer device configured to transfer the workpieces to the plurality of first and second processing tools;
a host computer configured to acquire an operational state and an operational schedule including information regarding a timing for maintenance from the plurality of first and second processing tools and configured to create a transfer plan including information on timings for the workpieces to be carried in and carried out of the plurality of first and second processing tools by the transfer device;
an upper-level controller configured to acquire the operational state, the operational schedule and the transfer plan of the plurality of first and second processing tools from the host computer;
a first group controller configured to acquire the operational state, the operational schedule and the transfer plan of the plurality of first processing tools from the upper-level controller and configured to generate a use plan for the first equipment based on at least one of the acquired operational state, operational schedule and transfer plan;
a second group controller configured to acquire the operational state, the operational schedule and the transfer plan of the plurality of second processing tools from the upper-level controller and configured to generate a use plan for the second equipment based on at least one of the acquired operational state, operational schedule and transfer plan;
a first shared controller configured to control processing timings of the first equipment and each of the plurality of first processing tools based on the use plan for the first equipment, the operational state of the first equipment, and use information including at least one of use reservation, inquiry, execution, and release information for the first equipment by each of the plurality of first processing tools; and
a second shared controller configured to control processing timings of the second equipment and each of the plurality of second processing tools based on the use plan for the second equipment, the operational state of the second equipment, and use information including at least one of use reservation, inquiry, execution, and release information for the second equipment by each of the plurality of second processing tools.

9. The production processing system of claim 8, further comprising a common equipment configured to be shared by the plurality of first and second processing tools, wherein the upper-level controller creates a use plan for the common equipment and controls a processing timing of the common equipment, based on at least one of the operational state, the operational schedule and the transfer plan of the plurality of first and second processing tools.

10. A control device for controlling a plurality of processing tools configured to process workpieces, an equipment configured to be shared by the plurality of processing tools, and a transfer device configured to transfer the workpieces to the plurality of processing tools, comprising:
an acquisition unit configured to acquire an operational state of the plurality of processing tools, an operational schedule including information regarding a timing for maintenance, and a transfer plan including information on timings for the workpieces to be carried in and out of the plurality of processing tools by the transfer device;
a use plan generating unit configured to create a use plan for the equipment based on at least one of the acquired operational state, operational schedule and transfer plan; and
a control unit configured to control processing timings of the equipment and each of the plurality of processing tools based on the use plan, the operational state of the equipment, and use information including at least one of use reservation, inquiry, execution, and release information for the equipment by each of the plurality of processing tools.

11. A control method for controlling a plurality of processing tools configured to process workpieces, an equipment configured to be shared by the plurality of processing tools, and a transfer device configured to transfer the workpieces to the plurality of processing tools, comprising:
acquiring an operational state of the plurality of processing tools, an operational schedule including information regarding a timing for maintenance, and a transfer plan including information on timings for the workpieces to be carried in and out of the plurality of processing tools by the transfer device;
creating a use plan for the equipment based on at least one of the acquired operational state, operational schedule and transfer plan; and
controlling processing timings of the equipment and each of the plurality of processing tools based on the use plan, the operational state of the equipment, and use information including at least one of use reservation, inquiry, execution, and release information for the equipment by each of the plurality of processing tools.

12. A non-transitory computer-readable storage medium storing a control program for controlling a plurality of processing tools configured to process workpieces, an equipment configured to be shared by the plurality of processing tools, and a transfer device configured to transfer the workpieces to the plurality of processing tools, the control program causing a computer to perform processes of:
acquiring an operational state of the plurality of processing tools, an operational schedule including information regarding a timing for maintenance, and a transfer plan including information on timings for the workpieces to be carried in and out of the plurality of processing tools by the transfer device;
creating a use plan for the equipment based on at least one of the acquired operational state, operational schedule and transfer plan; and
controlling processing timings of the equipment and each of the plurality of processing tools based on the use plan, the operational state of the equipment, and use information including at least one of use reservation, inquiry, execution, and release information for the equipment by each of the plurality of processing tools.
